(19) United States
(12) Patent Application Publication
(10) Pub. No.: US 2010/0017152 A1
(43) Pub. Date: Jan. 21, 2010

(54) Non-Contact Apparatus for Monitoring the Height of Contents of a Moving Container, a Monitoring Station Including the Apparatus and a Non-Contact Method of Monitoring the Height of Contents of a Container

(76) Inventors: Mark David George Potter, Coventry (GB); Steve Mark Dixon, Solihull (GB); John Reed, Warwickshire (GB); Stuart Mont Palmer, Warwickshire (GB)

Correspondence Address: James W Hiney, P O BOX 818, Middleburg, VA, 20118, US

(21) Appl. No.: 12/309,786

(22) PCT Filed: Jun. 11, 2007
(86) PCT No.: PCT/GB2007/002169

§ 371 Date: Jun. 19, 2009

(30) Foreign Application Priority Data
Jun. 10, 2006 (GB) 0611533.1

(51) Int. Cl. G01F 23/296; G06F 19/00

(52) U.S. Cl. 702/54; 702/55; 73/290 V

(57) ABSTRACT

A non-contact apparatus is provided for monitoring the height of contents of a moving container, such as a beverage can 24 on a conveyor 14. The apparatus comprises non-contact ultrasonic wave generation means comprising a first electromagnetic acoustic transducer 16 disposed to one side of a container 24 being monitored and adapted to produce an ultrasonic wave pulse in the container, and non-contact ultrasonic wave detector means comprising a second electromagnetic acoustic transducer 18 adapted to detect an ultrasonic signal and to generate a detection signal dependent upon the ultrasonic signal which is detected, the detector means being disposed at a different position to the side of a container 24 from the generation means. The apparatus further including signal processing means 20 adapted to process the detection signal generated by the ultrasonic wave detector means using the difference in transit times for two waves to provide an indication of the level of the contents in the container 24.

This invention relates to a non-contact apparatus for monitoring the height of contents of a moving container, a monitoring station including the apparatus and a non-contact method of monitoring the height of contents of a container.

It is a requirement in the food and drinks industry that containers are inspected to ensure that they contain the legally required minimum level of fluid, yet the business requirements are such as to limit the amount of overfilling. Systems are required to inspect for level and provide information to control systems.

A non-mechanical contact system is known which employs gamma radiation for detection of contents in beverage cans and bottles. A gamma radiation source is placed on the opposite side of a beverage can conveyor belt from a gamma radiation detector, and both are just below the height to which the beverage can should be filled. The beverage in the can will absorb some of the radiation. Hence if the can has beverage at the level of the source and detector, a lower radiation level will be detected at the detector than if the level of beverage in the can is below that level and the radiation is passing through the gas above the beverage. In this way, cans which have been insufficiently filled can be detected. From a safety point of view, gamma radiation in the workplace is undesirable.

Another known apparatus is disclosed in U.S. Pat. No. 6,234,023. This describes apparatus for determining fill level in beer cans. An ultrasonic source is provided which is in the form of a TEA CO₂ laser beam focused by a lens onto the beverage can moving on a canning line. A detector is provided in the form of a broadband electromagnetic acoustic transducer (EMAT) at the opposite side of the can. The detector detects two signals, a first signal representative of a wavefront transmitted directly through the contents of the container to the detector, and a second signal representative of a wavefront which has been reflected from the interface between the surface of the beverage and the environment above it in the can. The signals are processed and a determination of fill level is made on the basis of the difference in travel time for the two wavefronts. The laser source provides a strong ultrasonic signal which is required for the travel time analysis, but the laser equipment is complex and expensive.

According to one aspect of the invention there is provided a non-contact apparatus for monitoring the height of contents of a moving container, the apparatus comprising space defining means defining a container receiving space, non-contact ultrasonic wave generation means comprising a first electromagnetic acoustic transducer adapted to be disposed in use on one side of a container being monitored and to produce in use an ultrasonic wave pulse in a container being monitored, non-contact ultrasonic wave detector means comprising a second electromagnetic acoustic transducer adapted to detect an ultrasonic signal and to generate a detection signal dependent upon the ultrasonic signal which is detected, the detector means being arranged such that it is disposed at a different position to the side of a container from the generation means in use, and the apparatus further including signal processing means adapted to process the detection signal generated by the ultrasonic wave detector means in order to determine the height of the contents of the container, the arrangement being such that the signal processing means identifies a first signal which is representative of a first ultrasonic wave which has travelled directly though the contents of the container to the detector means without reflection independently of the height of the contents in the container, and a second signal that is representative of a second ultrasonic wave that has been reflected from the interface between the upper surface of the contents in the container and the environment above the contents, and in which the signal processing means uses the difference in transit times for the two waves to provide an indication of the level of the contents in the container, and in which the first and second waves are part of the same ultrasonic wavefront in three dimensions.

By using a dedicated electromagnetic acoustic transducer arranged as described to produce the ultrasonic wave pulse, the cost and complexity of the apparatus are reduced, and the system allows very accurate determination of fill level at high speed.

The apparatus of the invention can only be used however with containers which have a wall which is made of metal or includes metal. Thus, the apparatus can be used, for example, with aluminium drinks cans, and tin cans, and can also be used with foil lined cartons, and plastic bottles bearing a foil label.

Preferably, the first electromagnetic acoustic transducer is of a first construction adapted to produce in use an ultrasonic wave pulse in a container being monitored, and the second electromagnetic acoustic transducer is of a second construction different from the first construction and adapted to detect an ultrasonic signal. The transducers can thus be optimised for their different purposes.

The first electromagnetic acoustic transducer may be adapted to produce in use an ultrasonic wave pulse in a container being monitored which is of 100 microsecond duration or less, preferably of 20 microsecond duration or less, and in a preferred embodiment 5 microsecond duration or less. The shorter the duration of the pulse, the more accurately the fill level can be determined.

In one embodiment, the first electromagnetic acoustic transducer comprises a wire coil and the non-contact ultrasonic wave generation means further includes means to apply a current of at least 100 A, preferably at least 400 A through the wire coil to produce in use the ultrasonic wave pulse in a container being monitored. The strength of the pulse also improves the accuracy of determination of fill level.

In a preferred embodiment, the first electromagnetic acoustic transducer comprises a wire coil and the ultrasonic wave generation means further includes a capacitor and means to discharge the capacitor through the wire coil. The ultrasonic wave generation means preferably further includes means to charge the capacitor to 200 Volts or more, or even 500 Volts or more for discharge through the wire coil.

The first electromagnetic acoustic transducer may comprise a wire coil which is generally flat and may be generally in the form of a spiral. The spiral may have at least ten turns and preferably is no more than about 10 mm in diameter. In a preferred embodiment, the ultrasonic wave generation means is without a magnet, either in the form of a permanent magnet or an electromagnet. The wire coil when carrying the current, will generate a magnetic field to interact with eddy currents induced in the wall of the container, so no permanent magnet is required. A material with a low electrical conductivity but a high relative magnetic permeability, such as ferrite may be placed in proximity to the coil to significantly enhance ultrasonic generation efficiency. Thus the first electromagnetic acoustic transducer may comprise a wire coil on the face of a ferrite block, the wire coil facing the container receiving space defined by the space defining means.

The wire coil of the second electromagnetic transducer may be wound in at least one loop about an upright axis, so that one part of the loop is closer to the container being monitored, in use, than the other. The or each loop may be elongate in the direction of movement of a container through the space defined by the space defining means. The or each loop may be elongate horizontally so that one long side of the or each loop faces the space defined by the space defining means. Preferably, the wire coil of the second electromagnetic transducer is wound in a plurality of loops about an upright axis. The loops are preferably arranged such that the parts of the loops which are adjacent the container being monitored, in use, are aligned vertically so as to be the same distance from the wall of a container being monitored, in use. The or each loop may be wound around a core. At least an element of the core may be made of an electrically conductive material, such as copper. The electrically conductive element preferably forms at least the part of the core closest to the part of the loop which is furthest from the space defined by the space defining means. In this way, the electrically conductive element acts to screen the rear part of the loop from the surface of the container. At least an element of the core may be made of an insulating material. Preferably, the insulating element forms at least the part of the core closest to the part of the loop which is nearest to the space defined by the space defining means. In a preferred embodiment, the core comprises a laminate of a layer of electrically conductive material and a layer of an insulating material, the insulating material layer facing the space defined by the space defining means and the electrically conductive material layer facing away from the space defined by the pace defining means. The layer of electrically conductive material may be made of copper.

A magnet, which may be a permanent magnet or an electromagnet, may be provided above and below the or each wire coil of the second electromagnetic transducer. A strip of ferromagnetic material, such as steel, may be provided behind the or each wire coil of the second electromagnetic transducer. This further increases the magnetic field close to the surface of the container.

The second electromagnetic acoustic transducer may include a wire coil at the same height as the first electromagnetic acoustic transducer. The second electromagnetic transducer may comprise two wire coils, one above the other. In a preferred embodiment, the second electromagnetic transducer comprises two wire coils, one wire coil at the same height as the first electromagnetic acoustic transducer and the other wire coil at a height above the height of the wire coil of the first electromagnetic transducer. The upper wire coil can then be used to determine low fill levels by detecting the absence of a directly transmitted ultrasonic wave. The lower wire coil can produce the signal which is analysed to derive the travel times of the direct and indirect waves.

Preferably, the non-contact ultrasonic wave detector means is disposed on the opposite side of the space defined by the space defining means from the non-contact ultrasonic wave generation means.

According to another aspect of the invention there is provided a monitoring station for monitoring the height of contents of moving containers, the station comprising an apparatus according to the first aspect of the invention and a conveyor for conveying containers along a path through the space defined by the space defining means of the apparatus.

According to a further aspect of the invention there is provided a non-contact method of monitoring the height of contents of a container moved by a conveyor along a path, the container having a wall which is at least partly metallic, the method comprising: producing an ultrasonic wave pulse in the container by means of non-contact ultrasonic wave generation means comprising a first electromagnetic acoustic transducer disposed to one side of the container, and detecting an ultrasonic signal at a different position to the side of the container by means of non-contact ultrasonic wave detector means comprising a second electromagnetic acoustic transducer, generating a detection signal dependent upon the ultrasonic signal which is detected, and processing the detection signal generated by the ultrasonic wave detector means in order to determine the height of the contents of the container, the step of processing including the steps of identifying a first signal which is representative of a first ultrasonic wave which has travelled directly though the contents of the container to the detector means without reflection independently of the height of the contents in the container, and identifying a second signal that is representative of a second ultrasonic wave that has been reflected from the interface between the upper surface of the contents in the container and the environment above the contents, and using the difference in transit times for the two waves to provide an indication of the level of the contents in the container, the first and second waves being part of the same ultrasonic wavefront in three dimensions.

The first electromagnetic acoustic transducer is preferably of a first construction adapted to produce an ultrasonic wave pulse in the container, and the second electromagnetic acoustic transducer is preferably of a second construction different from the first construction and adapted to detect an ultrasonic signal.

The ultrasonic wave pulse produced in the container may be of 100 microsecond duration or less, preferably 20 microsecond duration or less, more preferably 5 microsecond duration or less.

In one embodiment, the first electromagnetic acoustic transducer comprises a wire coil and a current of at least 100 A, preferably at least 400 A, is applied through the wire coil to produce the ultrasonic wave pulse in the container.

In a preferred embodiment, the first electromagnetic acoustic transducer comprises a wire coil and the ultrasonic wave generation means further includes a capacitor, the capacitor being discharged through the wire coil to produce the ultrasonic wave pulse in the container. Preferably, the capacitor is charged to 200 Volts or more, or even 500 Volts or more, and discharged through the wire coil.

The ultrasonic signal may be detected by a wire coil of the second electromagnetic acoustic transducer at the same height as the first electromagnetic acoustic transducer. The second electromagnetic transducer may comprise two wire coils for detecting the ultrasonic signal, the coils being arranged one above the other. Preferably, the second electromagnetic transducer comprises two wire coils for detecting the ultrasonic signal, one wire coil at the same height as the first electromagnetic acoustic transducer and the other wire coil at a height above the height of the wire coil of the first electromagnetic transducer.

In a preferred embodiment, the ultrasonic signal is detected on the opposite side of the container from the side of the container in which the ultrasonic wave pulse is produced.

An embodiment of the invention will now be described by way of example and with reference to the accompanying drawings, in which:

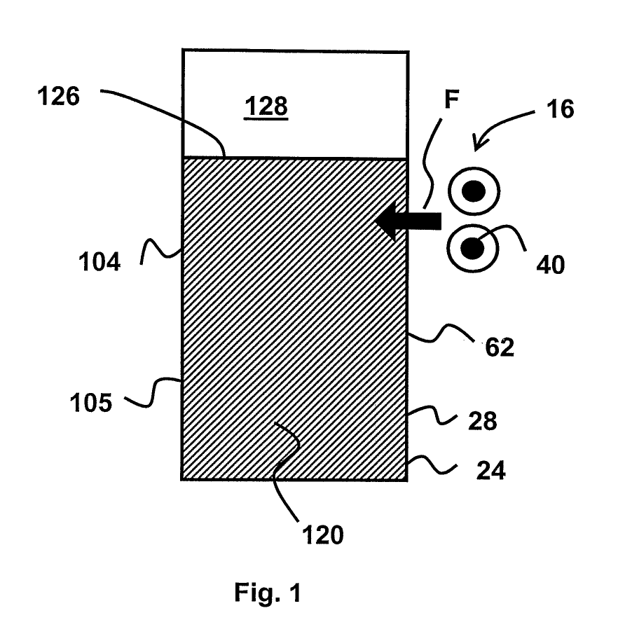

FIG. 1 is a schematic side elevation in cross section of a container and the non-contact ultrasonic wave generator of the embodiment;

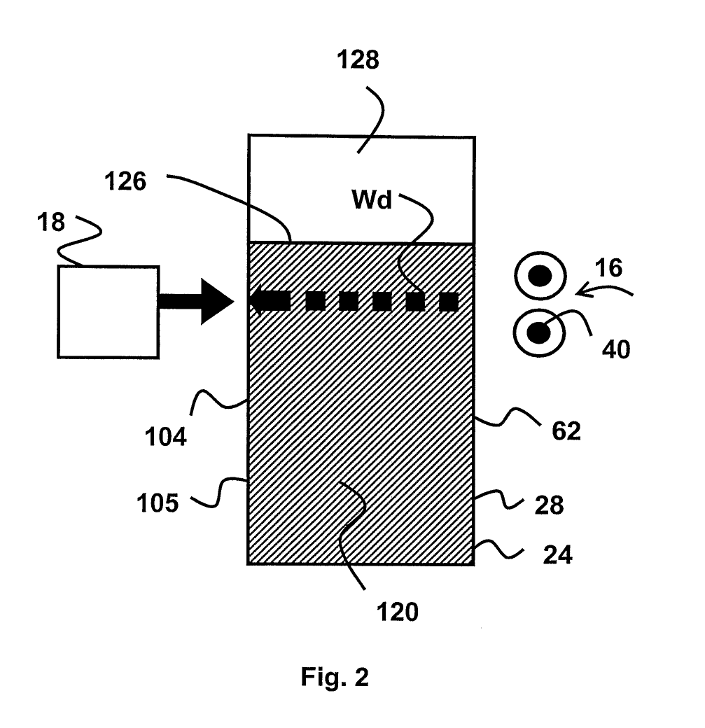

FIG. 2 is the view of FIG. 1 showing the non-contact ultrasonic wave detector and the direct path of an ultrasonic wave;

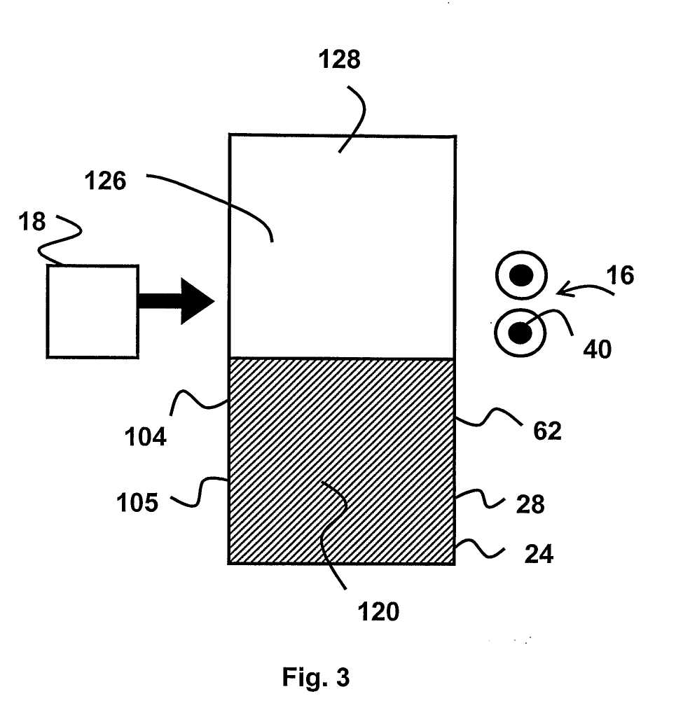

FIG. 3 is the view of FIG. 2 but showing the level of liquid in the container below the level of the generator and detector;

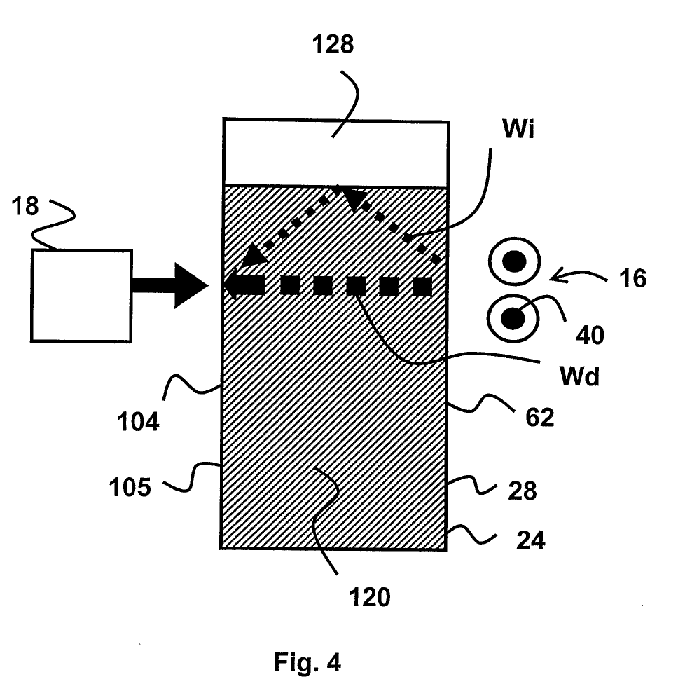

FIG. 4 is the view of FIG. 2 showing in addition the reflected path of an ultrasonic wave;

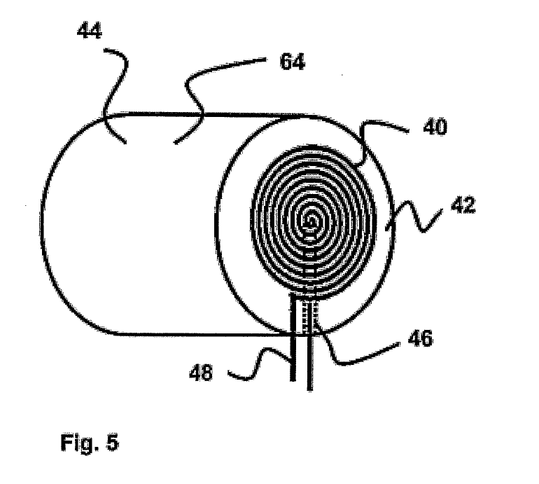

FIG. 5 is a perspective view of the non-contact ultrasonic wave generator of the embodiment;

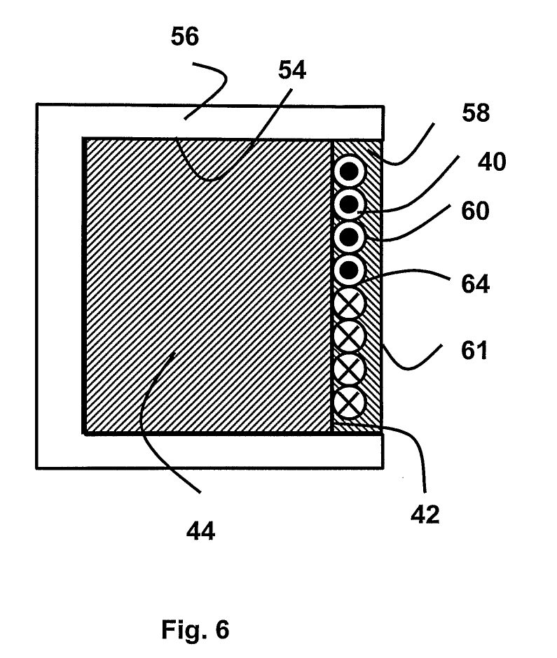

FIG. 6 shows the encapsulation of the non-contact ultrasonic wave generator of the embodiment;

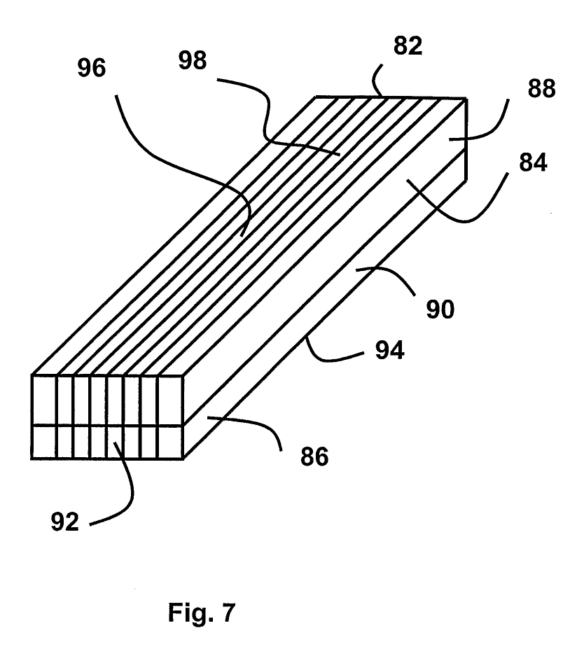

FIG. 7 shows the coil of the non-contact ultrasonic wave detector of the embodiment;

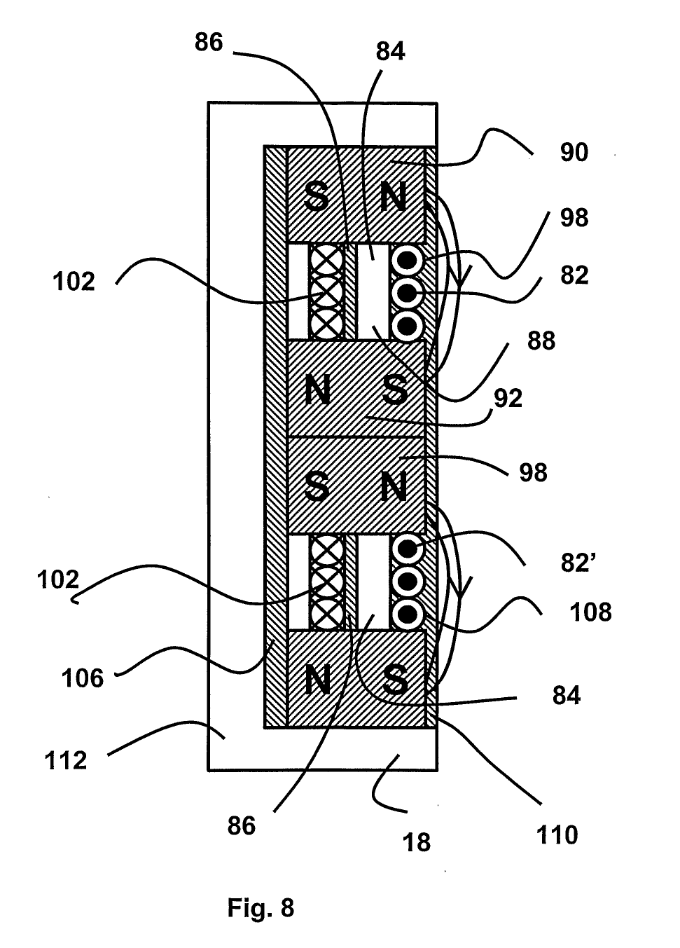

FIG. 8 shows the complete non-contact ultrasonic wave detector of the embodiment;

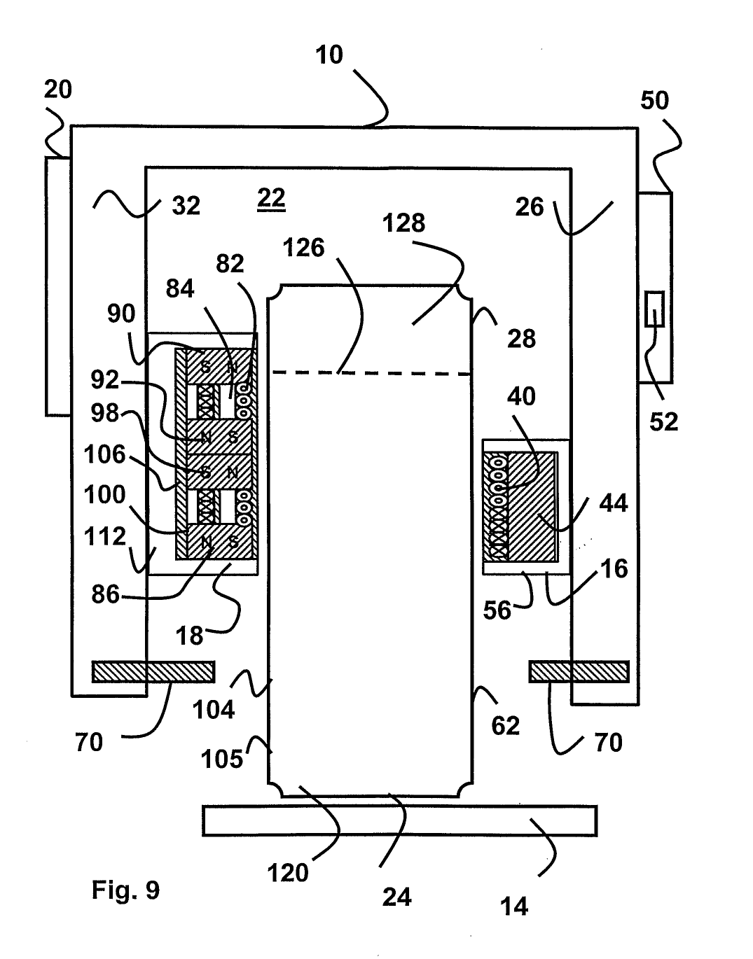

FIG. 9 shows the monitoring station of the embodiment.

The station 10 in a first embodiment of the invention comprises a frame 12, a conveyor 14, a first electromagnetic acoustic transducer 16, a second electromagnetic acoustic transducer 18 and a signal processor 20.

The frame 12 is generally in an inverted U shape defining a tunnel space 22 therethrough. The conveyor 14 runs through the frame 12 to carry containers in the form of beverage cans 24 thereon through the container receiving space 22 defined by the frame 12. The first electromagnetic transducer 16 is mounted to one upright 26 of the frame 12 so as to face into the space 22 and lie adjacent and facing the side 28 of a can 24 on the conveyor 14. The second electromagnetic transducer 18 is mounted to the opposite upright 32 of the frame 12 so as to face into the space 22 and lie adjacent and facing the side 105 of a can 24 on the conveyor 14.

The first electromagnetic acoustic transducer 16 (EMAT) comprises a spiral “pancake” wire coil 40 consisting of 11 turns of 0.25 mm diameter lacquered copper wire wound flat on the flat end surface 42 of a short ferrite cylinder 44 of approximately 15 mm diameter. This spiral coil 40 is about 10 mm in diameter. A small groove 46 in the flat end surface 42 of the ferrite cylinder 44 allows the inner end 48 of the coil 40 to be run out under the spiral coil. The coil 40 is then connected to an electrical device 50 that is arranged to pass a pulse of current through the coil 40. The electrical device 50 is arranged to pass a current pulse (or spike) through the coil 40 which is temporally sharp, being approximately 5 microseconds in duration. The current pulse is obtained from capacitor discharge through the coil 40, where the capacitor 52 has been charged to about 750 Volts. This provides current flow through the coil of about 250 Amps. The coil 40 and ferrite cylinder 44, of the first EMAT 16, are housed within a cavity 54 hollowed from an aluminium block 56 generally of cubic shape with one side open so that the front face 42 of the ferrite cylinder 44 with the coil 40 thereon is at the open face of the block 56. The front face 42 of the ferrite cylinder 44 with the coil 40 is encapsulated in epoxy resin 58, with the coil face 60 not more than 0.5 mm beneath the surface 61 of the epoxy resin layer 58. The coil face 60 is in close proximity to the surface 62 of the side 28 of the metal can 24 to be inspected at a standoff of between 0.5 and 1.5 mm. The centre 64 of the coil 40 is approximately 40 mm below the estimated average fill level of the can 24 as shown in FIG. 9. The frame 12 holds this EMAT 16 fixed in position on the canning line such that as cans 24 proceed down the line they all pass within 0.5 to 1.5 mm of the EMAT 16. An optical detector 70, mounted at a distance equal to half the diameter of a can 24, further upstream on the line, acts as the triggering sensor, sending a signal causing the first EMAT 16 to generate ultrasound in the can 24 each time a can 24 is at its closest point to the EMAT 16.

The frame 12 also holds a second EMAT 18 (the receive EMAT) on the opposite side of the can 24, at the same position down the line, as shown in FIG. 9. The second EMAT 18 comprises two coils 82 of 0.08 mm diameter lacquered copper wire wrapped around an elongate rectangular former 84 consisting of a copper strip 86 and an insulating layer 88 thereon as shown in FIG. 7. The former 84 may be made of stripboard, in which case the insulating layer 88 will be a laminated fabric made of layers of paper and cured phenolic resin. The former 84 thus has two long sides 90 which are part copper strip and part insulating layer. The wire is wrapped over the ends 92 and the other two sides 94, 96 of the former 84, namely the long side 94 which is copper strip 86 and the long side 96 which is all insulating layer 88. Each coil 82 is arranged with the elongate direction substantially horizontal and parallel to the direction in which cans 24 are conveyed through the space 22 by the conveyor 14. Each coil 82 on its former 84 is placed in between two permanent magnets 90, 92 such that the magnetic field B close to the surface of the coil 82 runs parallel to the flat front face 98 of the coil 82 and at right angles to the direction of the wires composing the coil 82, as shown in FIG. 8. Thus, each coil 82 on its former 84 is arranged with the insulating layer 88 facing the side of the can 24, and a magnet 90 on top of it and the other magnet 92 below it. The magnets 90, 92 are of elongate rectangular quadrilateral shape similar to the former 84, and have one long side of one polarity and the opposite long side of the opposite polarity. The magnets 90, 92 are arranged with opposite polarities facing forwards. Thus, as shown in FIG. 8, the top magnet 90 has its north pole side facing the can 24 and its south pole side facing rearwards, while the bottom magnet 92 has its south pole side facing the can 24 and its north pole side facing rearwards. The permanent magnet 98 on top of the lower coil 82′ of the second EMAT 18 has the reverse polarity from the permanent magnet 92 immediately above it, and the polarity of the magnet 100 below the lower coil 82′ is also accordingly reversed. The copper strip 86 acts to electromagnetically screen the rear 102 of the coil 82 from the adjacent surface 104 of the adjacent wall 105 of the can 24. In addition, a steel strip 106 runs beneath all the magnets 90, 92, 98, 100 in this EMAT 18 to form a magnetic return path and further increase the magnetic field close to the surface 104 of the can 24. The front face 108 of the receive EMAT 18 is encapsulated in epoxy resin 110 and all of the described components of the second EMAT 18 are mounted in a substantial aluminium case 112 in the same fashion at the generation EMAT 16.

The receive EMAT 18 is held within 0.5 mm of the surface 104 of the can wall, opposite to the generation EMAT 16 and positioned vertically on the frame 12 such that the lower coil 82′ is at the same vertical level as the generation EMAT 16 and the upper coil 82 is approximately 30 mm above this (see FIG. 9).

The frame 12 holding the first and second EMATs 16, 18 can be adjusted in terms of height and EMAT separation in order to accommodate cans 24 or other containers of different widths and expected fill levels.

The operation of the system is shown schematically in FIGS. 1 to 4. Referring to FIG. 1 of the drawings, an impulsive force F is applied to the wall 28 of a metal can 24, by pulsing current through the coil 40 of wire of the first EMAT 16 in close proximity to the can 24. Pulsing current through the wire of coil 40 induces an eddy current in the metallic wall 28 of the can 24. The eddy current interacts with the magnetic field of the coil 40, and this generates an impulsive force on the wall 28 of the can 24. The impulsive force generated on the metallic wall 28 generates an acoustic wave Wd in the contents 120 of the can 24. The contents 120 may be liquids, solids, a combination of these or any other substance that supports an ultrasonic wave. In a particular embodiment the contents 120 of the can 24 are beer.

The ultrasonic wave Wd will travel through the contents 120 of the can 24 and will arrive at the opposite wall 105 of the can 24 to that in which it was generated.

The ultrasonic wave Wd will force the wall 105 of the can 24 to move and this movement can be detected by the second electromagnetic acoustic transducer (EMAT) 18.

If the contents 120 of the can 24 are at a level 124 not up to the level at which the impulsive force is applied to the can 24 (as shown in FIG. 3) then little or no detectable amount of ultrasonic energy associated with the propagation of an ultrasonic wave through the contents 120 of the can 24 will be detected by the ultrasonic detector constituted by the second EMAT 18. This principle can be used to determine the level to which the can 24 is filled.

The ultrasonic wave Wd will propagate through the contents 120 of the can 24. By measuring the wave properties of the wave W when it arrives at the point at which it is detected, the ultrasonic properties of the container contents 120 can be calculated. These ultrasonic properties can be related to the physical properties of the contents 120. Such ultrasonic properties may be but are not limited to ultrasonic velocity, ultrasonic wave attenuation and ultrasonic wave dispersion. Where the contents 120 consist of two or more different phases, such as a liquid and a solid, the ultrasonic signal can be analysed to reveal such details as relative composition of each component. In addition, where some products become contaminated their ultrasonic properties change and thus contamination may also be detected using this ultrasonic approach. An example of this is milk or flavoured milk, which can curdle, changing its ultrasonic signature.

The impulsive force F generates waves W that propagate in a range of directions such that it is possible to detect a signal Wi that has reflected off the interface 126 between the contents 120 and the gas-space 128 in the can 24 above the contents 120 if the ultrasonic generator EMAT 16 and detector EMAT 18 are positioned below the fill level 126. The diagrams of FIGS. 2, 3 and 4 show the ultrasonic detector EMAT 18 and the generation source EMAT 16 at the same height, but this is not absolutely necessary to perform the measurement and the detector 18 and generation source 16 may be a different heights relative to the liquid level 124 or base 130 of the container. The signal Wd that propagates directly from the generator EMAT 16 to the detector EMAT 18 can be measured, and multiple reverberations of the direct signal travelling between opposite walls 28, 105 of the can can also be measured. From these measurements of the ultrasonic waves in the time domain together with knowledge of the dimensions of the can 24 it is possible in the signal processor 20 to calculate the fill level 124, irrespective of the value of ultrasonic velocity in the contents 120 of the can 24. Fill level heights 124 can be measured with typical accuracies of 0.1 mm or greater.

By measuring the transit times of ultrasonic waves Wd travelling directly through the can 24 and the ultrasonic waves Wi reflecting off the surface 124 of the contents 120 within the can 24, the velocity of sound in the contents 120 can be calculated in the signal processor 20 and then this value can be used in the calculation of the fill level. This then effectively automatically calibrates for variation in the ultrasonic wave's velocity in the contents 120 which could be due to variation in content or temperature. These measurements are taken using the lower coil 82′ of the receive EMAT 18; the upper coil 82 is used as a failsafe to detect very low fill levels by the absence of directly transmitted ultrasound Wd from the generation EMAT 16. The difference between transit times of the signals gives a value of liquid velocity for a known transit path length across the container. As time is measured one needs a velocity to calculate liquid level above the position of the detector. Also, this velocity value could be obtained from a look-up table or similar. This “self-calibration” is a useful feature of the system.

Using data acquisition, the system can store fill level data in electronic format and by calculating fill level in real time it can also be used to control the system to reject cans that are outside an acceptable fill level.

The station 10 of the embodiment may be used to inspect metal walled containers other than cans and such containers may contain solid or liquid content. The station may also be used for monitoring of fill level in containers in which only part of the wall is made of metal, such as foil lined cartons, and plastic bottles bearing a foil label.

Variations upon the embodiment described above will be apparent to the person skilled in the art and are encompassed herein.

In an alternative embodiment the ferrite used in the generation EMAT 16 is omitted or replaced with an alternative material, for example displaying low electrical conductivity but high relative magnetic permeability.

The receive EMAT 18 may not contain two coils 82, 82′. In one alternative embodiment the upper coil 82 is omitted, leaving only the other coil 82′, which is at the same level as the coil 40 of the first EMAT 16. The second EMAT may also contain three or more than three coils.

In another embodiment there are two or more discrete receive EMATs.

The generation EMAT 16 and/or the receive EMAT 18 may have coils 40, 82 of a different number of turns, wire diameter or geometry from that shown.

In a further embodiment electromagnets are used instead of the permanent magnets 90, 92, 98 100.

In another embodiment the steel strip 106 used to strengthen the magnetic field close to the surface in the receive EMAT 18 is omitted.

Alternative encapsulation may be used for the generation and/or receive EMATs 16, 18.

A different triggering mechanism may be used to activate the generation EMAT 18 when in proximity to the wall 28 of a can 24.

The system may operate whereby the velocity of ultrasound in the contents is assumed to be a particular value or a value for the velocity is taken from a look-up table, empirical data or similar.

The copper strip 86 may be omitted in another embodiment as this part of the coil 82 is much further from the can wall than the part of the coil 82 at the front of the EMAT detector 18.

The coil 40 may be within 10 mm of the surface of the container to be monitored.

The eddy current interacts with the magnetic field of the coil 40, but may also interact with a separate magnetic field, which may be from an electromagnet or a permanent magnet optionally provided in the system.

1. A non-contact apparatus for monitoring the height of contents of a moving container, the apparatus comprising space defining means defining a container receiving space, non-contact ultrasonic wave generation means comprising a first electromagnetic acoustic transducer adapted to be disposed in use to one side of a container being monitored and to produce in use an ultrasonic wave pulse in a container being monitored, non-contact ultrasonic wave detector means comprising a second electromagnetic acoustic transducer adapted to detect an ultrasonic signal and to generate a detection signal dependent upon the ultrasonic signal which is detected, the detector means being arranged such that it is disposed at a different position to the side of a container from the generation means in use, and the apparatus further including signal processing means adapted to process the detection signal generated by the ultrasonic wave detector means in order to determine the height of the contents of the container, the arrangement being such that the signal processing means identifies a first signal which is representative of a first ultrasonic wave which has travelled directly though the contents of the container to the detector means without reflection independently of the height of the contents in the container, and a second signal that is representative of a second ultrasonic wave that has been reflected from the interface between the upper surface of the contents in the container and the environment above the contents, and in which the signal processing means uses the difference in transit times for the two waves to provide an indication of the level of the contents in the container, and in which the first and second waves are part of the same ultrasonic wavefront in three dimensions.

2. An apparatus as claimed in claim 1, wherein the first electromagnetic acoustic transducer is of a first construction adapted to produce in use an ultrasonic wave pulse in a container being monitored, and the second electromagnetic acoustic transducer is of a second construction different from the first construction and adapted to detect an ultrasonic signal.

3. An apparatus as claimed in claim 1 or claim 2, wherein the first electromagnetic acoustic transducer is adapted to produce in use an ultrasonic wave pulse in a container being monitored which is of 100 microsecond duration or less.

4. An apparatus as claimed in claim 1 or claim 2, wherein the first electromagnetic acoustic transducer is adapted to produce in use an ultrasonic wave pulse in a container being monitored which is of 20 microsecond duration or less.

5. An apparatus as claimed in claim 1 or claim 2, wherein the first electromagnetic acoustic transducer is adapted to produce in use an ultrasonic wave pulse in a container being monitored which is of 5 microsecond duration or less.

6. An apparatus as claimed in any preceding claim, wherein the first electromagnetic acoustic transducer comprises a wire coil and the non-contact ultrasonic wave generation means further includes means to apply a current of at least 100 A through the wire coil to produce in use the ultrasonic wave pulse in a container being monitored.

7. An apparatus as claimed in any preceding claim, wherein the first electromagnetic acoustic transducer comprises a wire coil and the non-contact ultrasonic wave generation means further includes means to apply a current of at least 400 A through the wire coil to produce in use the ultrasonic wave pulse in a container being monitored.

8. An apparatus as claimed in any preceding claim, wherein the first electromagnetic acoustic transducer comprises a wire coil and the ultrasonic wave generation means further includes a capacitor and means to discharge the capacitor through the wire coil.

9. An apparatus as claimed in claim 8, wherein the ultrasonic wave generation means further includes means to charge the capacitor to 200 Volts or more for discharge through the wire coil.

10. An apparatus as claimed in claim 8, wherein the ultrasonic wave generation means further includes means to charge the capacitor to 500 Volts or more for discharge through the wire coil.

11. An apparatus as claimed in any preceding claim, wherein the first electromagnetic acoustic transducer comprises a wire coil which is generally flat.

12. An apparatus as claimed in any preceding claim, wherein the first electromagnetic acoustic transducer comprises a wire coil which is generally in the form of a spiral.

13. An apparatus as claimed in claim 12, wherein the spiral has at least ten turns.

14. An apparatus as claimed in claim 12 or claim 13, wherein the spiral is no more than about 10 mm in diameter.

15. An apparatus as claimed in any preceding claim, wherein the ultrasonic wave generation means is without a magnet.

16. An apparatus as claimed in any preceding claim, wherein the first electromagnetic acoustic transducer comprises a wire coil on the face of a ferrite block, the wire coil facing the container receiving space defined by the space defining means.

17. An apparatus as claimed in any preceding claim, wherein the wire coil of the second electromagnetic transducer is wound in at least one loop about an upright axis, so that one part of the loop is closer to the container being monitored, in use, than the other.

18. An apparatus as claimed in claim 17, wherein the or each loop is elongate in the direction of movement of a container through the space defined by the space defining means.

19. An apparatus as claimed in claim 17 or claim 18, wherein the or each loop is elongate horizontally so that one long side of the or each loop faces the space defined by the space defining means.

20. An apparatus as claimed in claim 17, 18 or 19, wherein the wire coil of the second electromagnetic transducer is wound in a plurality of loops about an upright axis.

21. An apparatus as claimed in claim 20, wherein the loops are arranged such that the parts of the loops which are adjacent the container being monitored, in use, are aligned vertically so as to be the same distance from the wall of a container being monitored, in use.

22. An apparatus as claimed in any of claims 17 to 21, wherein the or each loop is wound around a core.

23. An apparatus as claimed in claim 22, wherein at least an element of the core is made of an electrically conductive material.

24. An apparatus as claimed in claim 23, wherein or each electrically conductive element of the core is made of copper.

25. An apparatus as claimed in claim 23 or claim 24, wherein the electrically conductive element forms at least the part of the core closest to the part of the loop which is furthest from the space defined by the space defining means.

26. An apparatus as claimed in any of claims 22 to 25, wherein at least an element of the core is made of an insulating material.

27. An apparatus as claimed in claim 26, wherein the insulating element forms at least the part of the core closest to the part of the loop which is nearest to the space defined by the space defining means.

28. An apparatus as claimed in claim 22, wherein the core comprises a laminate of a layer of electrically conductive material and a layer of an insulating material, the insulating material layer facing the space defined by the space defining means and the electrically conductive material layer facing away from the space defined by the space defining means.

29. An apparatus as claimed in claim 28, wherein the layer of electrically conductive material is made of copper.

30. An apparatus as claimed in any preceding claim, wherein a magnet is provided above and below the or each wire coil of the second electromagnetic transducer.

31. An apparatus as claimed in any preceding claim, wherein a strip of ferromagnetic material is provided behind the or each wire coil of the second electromagnetic transducer.

32. An apparatus as claimed in any preceding claim, wherein the second electromagnetic acoustic transducer includes a wire coil at the same height as the first electromagnetic acoustic transducer.

33. An apparatus as claimed in any preceding claim, wherein the second electromagnetic transducer comprises two wire coils, one above the other.

34. An apparatus as claimed in any preceding claim, wherein the second electromagnetic transducer comprises two wire coils, one wire coil at the same height as the first electromagnetic acoustic transducer and the other wire at a height above the height of the wire coil of the first electromagnetic transducer.

35. An apparatus as claimed in any preceding claim, wherein the non-contact ultrasonic wave detector means is disposed on the opposite side of the space defined by the space defining means from the non-contact ultrasonic wave generation means.

36. A monitoring station for monitoring the height of contents of moving containers, the station comprising an apparatus as claimed in any preceding claim and a conveyor for conveying containers along a path through the space defined by the space defining means of the apparatus.

37. A monitoring station as claimed in claim 36, wherein the second electromagnetic acoustic transducer is elongate in the direction of the path of the conveyor.

38. A non-contact method of monitoring the height of contents of a container moved by a conveyor along a path, the container having a wall which is at least partly metallic, the method comprising: producing an ultrasonic wave pulse in the container by means of non-contact ultrasonic wave generation means comprising a first electromagnetic acoustic transducer disposed to one side of the container, and detecting an ultrasonic signal at a different position to the side of the container by means of non-contact ultrasonic wave detector means comprising a second electromagnetic acoustic transducer, generating a detection signal dependent upon the ultrasonic signal which is detected, and processing the detection signal generated by the ultrasonic wave detector means in order to determine the height of the contents of the container, the step of processing including the steps of identifying a first signal which is representative of a first ultrasonic wave which has travelled directly though the contents of the container to the detector means without reflection independently of the height of the contents in the container, and identifying a second signal that is representative of a second ultrasonic wave that has been reflected from the interface between the upper surface of the contents in the container and the environment above the contents, and using the difference in transit times for the two waves to provide an indication of the level of the contents in the container, the first and second waves being part of the same ultrasonic wavefront in three dimensions.

39. A method as claimed in claim 38, wherein the first electromagnetic acoustic transducer is of a first construction adapted to produce an ultrasonic wave pulse in the container, and the second electromagnetic acoustic transducer is of a second construction different from the first construction and adapted to detect an ultrasonic signal.

40. A method as claimed in claim 38 or claim 39, wherein the ultrasonic wave pulse produced in the container is of 100 microsecond duration or less.

41. A method as claimed in claim 38 or claim 39, wherein the ultrasonic wave pulse produced in the container is of 20 microsecond duration or less.

42. A method as claimed in claim 38 or claim 39, wherein the ultrasonic wave pulse produced in the container is of 5 microsecond duration or less.

43. A method as claimed in any of claims 38 to 42, wherein the first electromagnetic acoustic transducer comprises a wire coil and a current of at least 100 A is applied through the wire coil to produce the ultrasonic wave pulse in the container.

44. A method as claimed in any of claims 38 to 42, wherein the first electromagnetic acoustic transducer comprises a wire coil and a current of at least 400 A is applied through the wire coil to produce the ultrasonic wave pulse in the container.

45. A method as claimed in any of claims 38 to 44, wherein the first electromagnetic acoustic transducer comprises a wire coil and the ultrasonic wave generation means further includes a capacitor, the capacitor being discharged through the wire coil to produce the ultrasonic wave pulse in the container.

46. A method as claimed in claim 45, wherein the capacitor is charged to 200 Volts or more and discharged through the wire coil.

47. A method as claimed in claim 45, wherein the capacitor is charged to 500 Volts or more and discharged through the wire coil.

48. A method as claimed in any of claims 38 to 47, wherein the ultrasonic signal is detected by a wire coil of the second electromagnetic acoustic transducer at the same height as the first electromagnetic acoustic transducer.

49. A method as claimed in any of claims 38 to 47, wherein the second electromagnetic transducer comprises two wire coils for detecting the ultrasonic signal, the coils being arranged one above the other.

50. A method as claimed in any of claims 38 to 49, wherein the second electromagnetic transducer comprises two wire coils for detecting the ultrasonic signal, one wire coil at the same height as the first electromagnetic acoustic transducer and the other wire coil at a height above the height of the wire coil of the first electromagnetic transducer.

51. A method as claimed in any of claims 38 to 50, wherein the ultrasonic signal is detected on the opposite side of the container from the side of the container in which the ultrasonic wave pulse is produced.

52. A non-contact apparatus for monitoring the height of contents of a moving container, the apparatus comprising non-contact ultrasonic wave generation means comprising a first electromagnetic acoustic transducer to produce in use an ultrasonic wave pulse in a container being monitored, non-contact ultrasonic wave detector means comprising a second electromagnetic acoustic transducer adapted to detect an ultrasonic signal and to generate a detection signal dependent upon the ultrasonic signal which is detected, and the apparatus further including signal processing means adapted to process the detection signal generated by the ultrasonic wave detector means in order to determine the height of the contents of the container, the arrangement being such that the signal processing means identifies a first signal which is representative of a first ultrasonic wave which has travelled directly though the contents of the container to the detector means without reflection independently of the height of the contents in the container, and a second signal that is representative of a second ultrasonic wave that has been reflected from the interface between the upper surface of the contents in the container and the environment above the contents, and in which the signal processing means uses the difference in transit times for the two waves to provide an indication of the level of the contents in the container, and in which the first and second waves are part of the same ultrasonic wavefront in three dimensions.
